(19) United States
(12) Patent Application Publication
(10) Pub. No.: US 2008/0074891 A1
(43) Pub. Date: Mar. 27, 2008

(54) Light

(76) Inventor: Chih-Cheng Chuang, Taipei (TW)

Correspondence Address: BACON & THOMAS, PLLC, 625 SLATERS LANE, FOURTH FLOOR, ALEXANDRIA, VA, 22314, US

(21) Appl. No.: 11/527,636

(22) Filed: Sep. 27, 2006

(51) Int. Cl. F21V 11/00

(52) U.S. Cl. 362/351

(57) ABSTRACT

The present invention is to provide a light comprising a shade, one or more reflection members facing an inner surface of the shade, and one or more light-emitting members each provided at one end of each of the reflection members. The reflection members and the light-emitting members are concealed by the shade so as to protect the reflection members and the light-emitting members. Light emitted by the light-emitting members is transmitted through the shade after being deflected by the reflection members.

### FIELD OF THE INVENTION

The present invention relates to lighting equipment and more particularly to an improved light adapted to mount, for example, on the rear of an automobile.

### BACKGROUND OF THE INVENTION

Our life has entered a new era as technologies make progress significantly in recent several decades. It is typical for urban people to work or travel by driving a car or motorcycle. Thus, many cars and motorcycles running on a road is a common scene. It is important for drivers to apply rules of the road while driving. Otherwise, traffic accidents may occur. A motor vehicle is typically equipped with indicator lights. A driver may know that a front car is preparing to make a left or right turn when a left or right indicator light of the front car is flashing. Thus, the driver may take corresponding actions immediately for the safety of his or her car.

In another aspect, more motor vehicle owners would like to modify the appearance of their cars and motorcycles. One of important items to be modified is light. Thus, many car and motorcycle manufacturers spent a lot of money and time in the development of lights. As eyes are the windows of soul so lights are the eyes of motor vehicle. It is common for a person to consider both performance and appearance of a car before buying the car. Thus, a car having dazzling lights is definitely more attractive. A person may talk to friends or collect information about attractive automobile lights whether he or she has owned a car or not.

It is typical for a car owner to adhere dazzling stickers to lights of his or her car so as to be visually aesthetic. Further, some car owners may equip a car with lights having corrugated shades so as to achieve the dazzling effect of reflections. However, people are gradually not satisfied with such conventional light shades of dull design. Further, its bulb has a shortened life. Hence, such lights (e.g., indicator lights) bring a lot of trouble to car drivers. Thus, it is desirable among car manufacturers to provide a highly safe automobile light having a dazzling appearance in order to enable a driver of the automobile to move place to place with comfort and ease.

### SUMMARY OF THE INVENTION

After considerable research and experimentation, a light according to the present invention has been devised so as to overcome the above drawbacks (e.g., dull light shade, unattractiveness, etc.) of the prior art.

It is an object of the present invention to provide a light comprising a shade, one or more reflection members facing an inner surface of the shade, and one or more light-emitting members each provided at one end of each of the reflection members. The reflection members and the light-emitting members are concealed by the shade so as to protect the reflection members and the light-emitting members. Light emitted by the light-emitting members is transmitted through the shade after being deflected by the reflection members. As a result, a dazzling effect is obtained. Further, the light-emitting member is flash in nature. By utilizing the present invention, the shade can concentrate light so as to be dazzling.

The above and other objects, features and advantages of the present invention will become apparent from the following detailed description taken with the accompanying drawings.

### BRIEF DESCRIPTION OF THE DRAWINGS

FIG. 1 is a perspective view of a preferred embodiment of light according to the invention; and

FIG. 2 is a rear view of a car equipped with two lights of the invention on its rear.

### DETAILED DESCRIPTION OF THE PREFERRED EMBODIMENTS

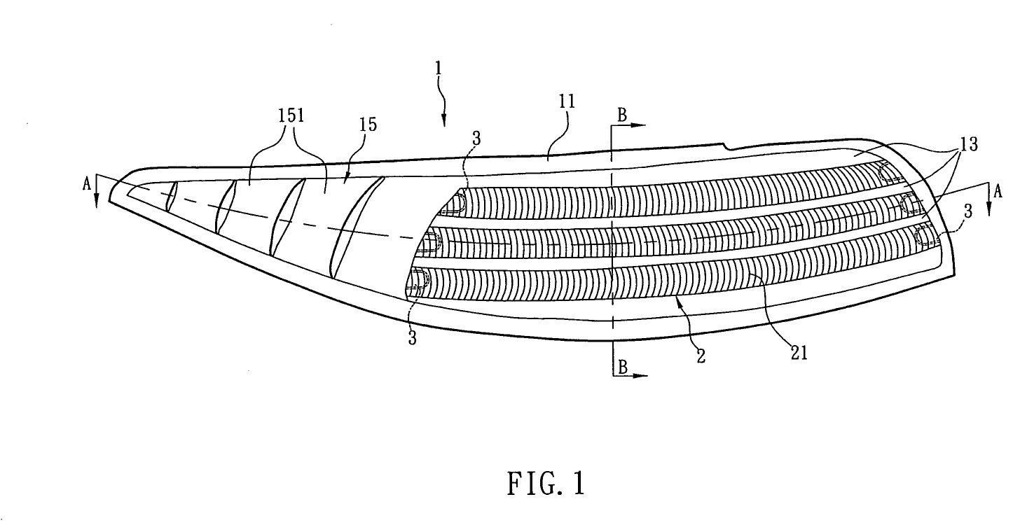

Referring to FIG. 1, a light in accordance with a preferred embodiment of the invention comprises a shade 1, a plurality of reflection members 2, and a plurality of light-emitting members 3. Each component is discussed in detailed below.

The elongate reflection members 2 are provided facing an inner surface of the shade 1. Each light-emitting member 3 is provided at either end of the reflection member 2. The reflection members 2 and the light-emitting members 3 are concealed by the shade 1. Thus, the reflection members 2 and the light-emitting members 3 are protected. Light emitted by the light-emitting members 3 is transmitted through the shade 1 after being deflected by the reflection members 2. As a result, a dazzling effect is obtained. Further, the light-emitting member 3 is flash in nature. The shade 1 can concentrate light so as to be more dazzling.

Referring to FIG. 1 again, in the preferred embodiment the elongate shade 1 comprises a peripheral frame 11 and a transparent zone 13 confined by the frame 11. Emitted light is reflected by the frame 11 so as to be dazzling. Moreover, light is transmitted evenly out of the shade 1 through the transparent zone 13.

Referring to FIG. 1 again, in the preferred embodiment the reflection members 2 are provided in the transparent zone 13. The reflection member 2 comprises a plurality of parallel longitudinal wrinkles 21 facing the inner surface of the shade 1. Thus, light emitted by the light-emitting members 3 travels to the reflection members 2. Further, the wrinkles 21 concentrate the light so as to be dazzling.

Referring to FIG. 1 again, in the preferred embodiment a decorative member 15 is provided at one end of the shade 1 confined by the frame 11 and the transparent zone 13. The decorative member 15 comprises a plurality of raised blocks 151 which are located between one end of the shade 1 and the transparent zone 13. By configuring as above, light reflected by the decorative member 15 and the frame 11 can bring about a dazzling effect. As a result, the shade 1 is visually attractive.

Referring to FIG. 1 again, in the preferred embodiment one set of light-emitting members 3 are provided at a joining portion of the transparent zone 13 and the decorative member 15. In detail, one set of light-emitting members 3 are concealed at one ends of the reflection members 2 and the other set of light-emitting members 3 are concealed at the other ends of the reflection members 2. The light-emitting member 3 is implemented as a LED (light-emitting diode). Thus, light emitted by one set of light-emitting members 3 can travel from one ends of the reflection members 2 to the other ends thereof.

Referring to FIG. 1 again, in the preferred embodiment one ends of the reflection members 2 are located at the joining portion of the transparent zone 13 and the decorative member 15, and the other ends of the reflection members 2 are located at the other end of the shade 1. Thus, emitted light can travel either from one ends of the reflection members 2 to the other ends thereof or from the other ends of the reflection members 2 to one ends thereof.

Referring to FIG. 1 again, in the preferred embodiment the wrinkles 21 are either linear or spiral and are equally spaced between both ends of the reflection member 2. The wrinkles 21 are unique in shape and are attractive. The wrinkles 21 can concentrate emitted light so as to be dazzling. While the wrinkles 21 are either linear or spiral in the preferred embodiment, it is understood that the wrinkles 21 can have other shapes in other preferred embodiments.

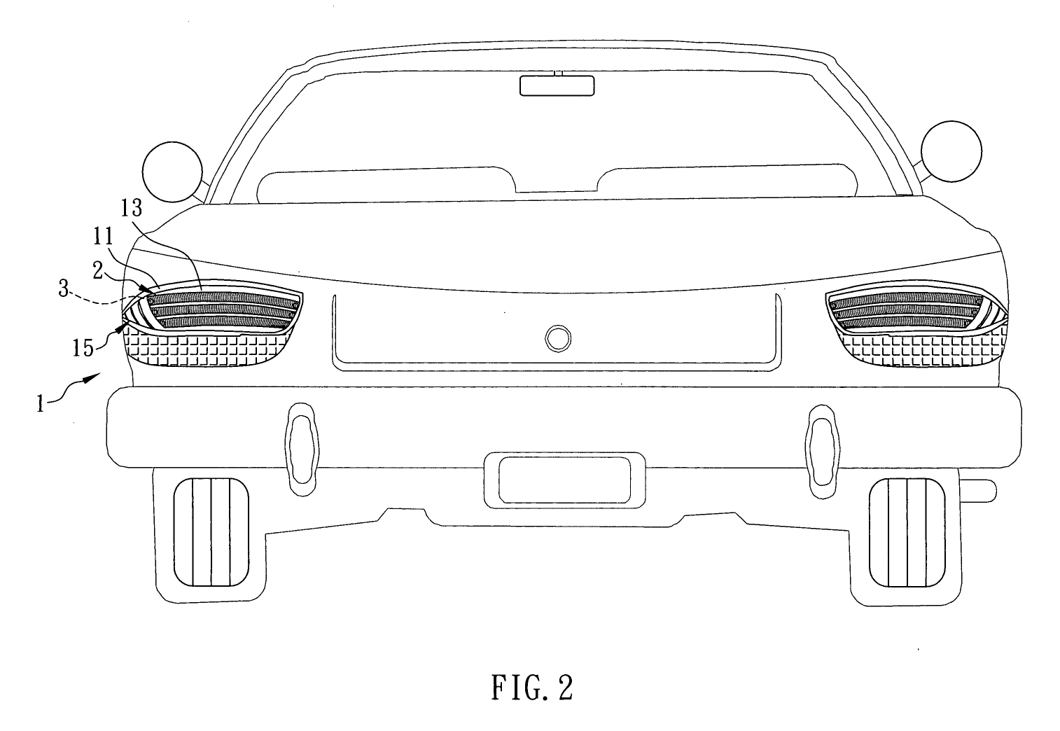

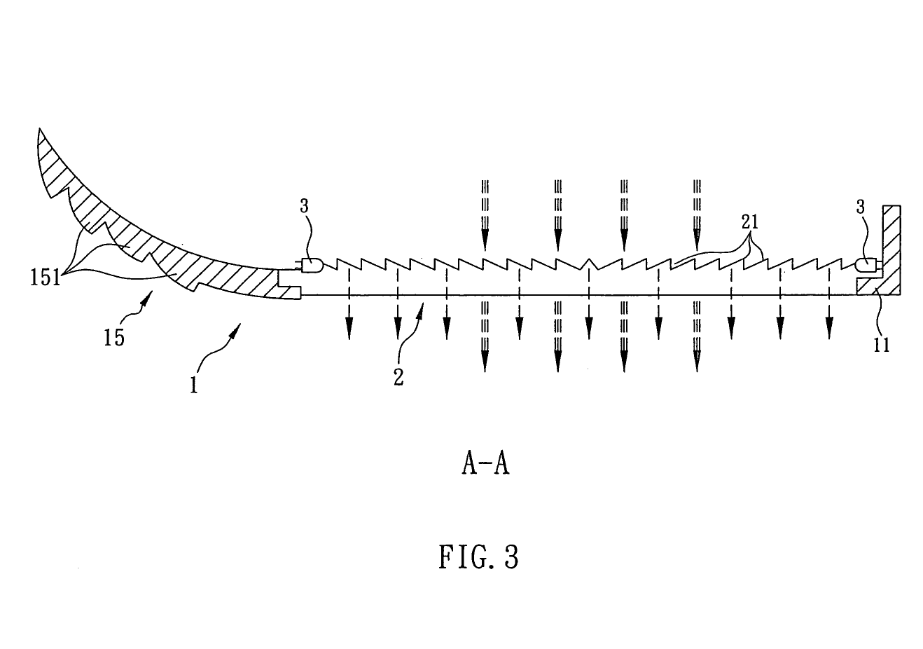

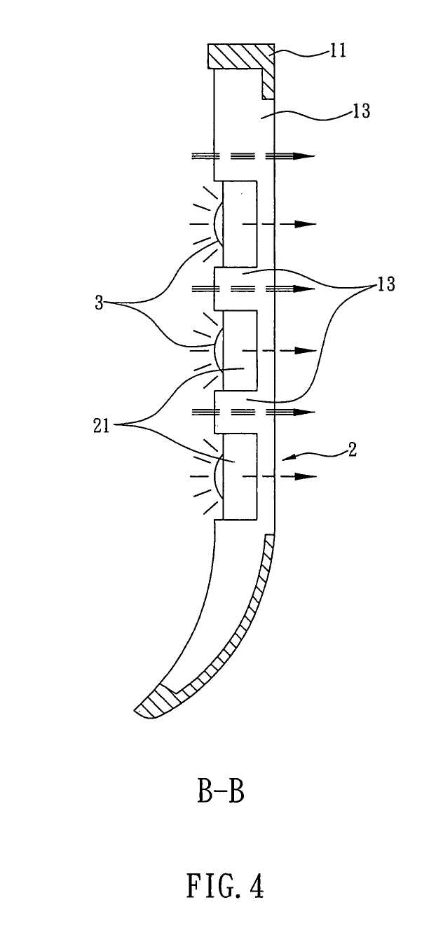

Referring to FIG. 2, in the preferred embodiment the lights are mounted on the rear of a car. While the lights are adapted to mount on the rear of a car, it is understood that the lights can also be mounted on a fish tank, or as a portion of a chandelier in other preferred embodiments.

While the invention herein disclosed has been described by means of specific embodiments, numerous modifications and variations could be made thereto by those skilled in the art without departing from the scope and spirit of the invention set forth in the claims.

1. A light comprising:
a shade comprising a peripheral frame and a transparent zone confined by the frame;
a plurality of one or more reflection members provided within the transparent zone and facing an inner surface of the shade, each of the reflection members comprising a plurality of parallel longitudinal wrinkles facing the inner surface of the shade; and
a plurality of one or more light-emitting members facing the inner surface of the shade, each of the light-emitting members being located at either end of each of the reflection members.

2.-3. (canceled)

4. The light of claim 3, further comprising a decorative member mounted at one end of the shade confined by the frame and the transparent zone, the decorative member including a plurality of raised blocks located between one end of the shade and the transparent zone.

5. The light of claim 4, wherein one end of each of the reflection members is located at a joining portion of the transparent zone and the decorative member, and the other end thereof is located at the other end of the shade.

6. The light of claim 5, wherein the light-emitting members are located at a joining portion of the transparent zone and the frame at the other end of the shade, and wherein the light-emitting members are concealed at the other end of the reflection members.

7. The light of claim 5, wherein the wrinkles are linear and are equally spaced between both ends of the reflection member.

8.-13. (canceled)
